(19) United States
(12) Patent Application Publication
(10) Pub. No.: US 2016/0009565 A1
(43) Pub. Date: Jan. 14, 2016

(54) PROCESS FOR THE SYNTHESIS OF HYDROCYANIC ACID FROM FORMAMIDE PACKED AFTER-REACTOR

(71) Applicant: BASF SE, Ludwigshafen (DE)

(72) Inventors: Ralf BOEHLING, Lorsch (DE); Michael SCHIPPER, Ludwigshafen (DE); Jens BERNNAT, Gruenstadt (DE); Wilhelm WEBER, Neustadt (DE); Peter PETERSEN, Ludwigshafen (DE)

(73) Assignee: BASF SE, Ludwigshafen (DE)

(21) Appl. No.: 14/771,971

(22) PCT Filed: Feb. 28, 2014
(86) PCT No.: PCT/EP14/53936

§ 371 Date: Sep. 1, 2015

Related U.S. Application Data
(60) Provisional application No. 61/771,100, filed on Mar. 1, 2013.

(30) Foreign Application Priority Data
Mar. 1, 2013 (EP) 13157414.7

(51) Int. Cl. C01C 3/02

(52) U.S. Cl. CPC C01C 3/0204

(57) ABSTRACT

Process for preparing hydrocyanic acid by catalytic dehydration of gaseous formamide in at least one main reactor and a downstream after-reactor and also the use of an after-reactor in a process for preparing hydrocyanic acid by catalytic dehydration of gaseous formamide.

The present invention relates to a process for preparing hydrocyanic acid by catalytic dehydration of gaseous formamide in at least one main reactor and a downstream after-reactor and also the use of an after-reactor in a process for preparing hydrocyanic acid by catalytic dehydration of gaseous formamide.

Hydrocyanic acid is an important basic chemical which serves as starting material in, for example, numerous organic syntheses such as the preparation of adiponitrile, methacrylic esters, methionine and complexing agents (NTA, EDTA). In addition, hydrocyanic acid is required for the preparation of alkali metal cyanides which are used in mining and in the metallurgical industry.

The largest amount of hydrocyanic acid is produced by reaction of methane (natural gas) and ammonia. In the Andrussov process, atmospheric oxygen is simultaneously introduced. In this way, the preparation of hydrocyanic acid proceeds autothermally. In contrast thereto, the BMA process of Degussa AG is carried out in the absence of oxygen. The endothermic catalytic reaction of methane with ammonia is therefore operated externally using a heating medium (methane or H₂) in the BMA process. A disadvantage of these processes is the high unavoidable formation of ammonium sulfate since the reaction of methane can be carried out economically only when using an excess of NH₃. The unreacted ammonia is scrubbed out of the crude process gas by means of sulfuric acid.

A further important process for preparing HCN is the SOHIO process. In the ammonoxidation of propene/propane to form acrylonitrile, about 10% (based on propene/propane) of hydrocyanic acid is formed as by-product.

A further important process for the industrial preparation of hydrocyanic acid is thermal dehydration of formamide under reduced pressure, which proceeds according to the equation (I):

HCONH₂→HCN+H₂O (I)

This reaction is accompanied by the decomposition of formamide according to equation (II) to form ammonia and carbon monoxide:

HCONH₂→NH₃+CO (II)

Ammonia is scrubbed out of the crude gas by means of sulfuric acid. However, due to the high selectivity, only very little ammonium sulfate is obtained.

The ammonia formed catalyses the polymerization of the desired hydrocyanic acid and thus leads to impairment of the quality of the hydrocyanic acid and a reduction in the yield of the desired hydrocyanic acid. The polymerization of hydrocyanic acid and the associated formation of soot can be suppressed by the addition of small amounts of oxygen in the form of air, as disclosed in EP-A-0 209 039. EP-A-0 209 039 discloses a process for the thermolytic dissociation of formamide over highly sintered shaped aluminum oxide or aluminum oxide-silicon oxide bodies or over high-temperature-corrosion-resistant shaped chromium-nickel stainless steel bodies. According to the examples in EP-A-0 209 039, conversions of from 97.5% to 98.6% and selectivities of from 94.8% to 96.7% are achieved.

Further processes for preparing hydrocyanic acid by catalytic dehydration of formamide are disclosed in the prior art.

Thus, WO 2004/050582 relates to a process for preparing hydrocyanic acid by catalytic dehydration of gaseous formamide in a reactor which has an internal reactor surface composed of a steel comprising iron and also chromium and nickel, with the reactor preferably not comprising any additional internals and/or catalysts. According to the examples, hydrocyanic acid selectivities in the range from 90 to 98.5% and formamide conversions in the range from 70 to 97% are achieved.

WO 2006/027176 discloses a process for preparing hydrocyanic acid by catalytic dehydration of gaseous formamide, in which a formamide-comprising recycle stream is obtained from the product mixture in the dehydration and is recirculated to the dehydration, with the formamide-comprising recycle stream comprising from 5 to 50% by weight of water. According to paragraph [0022], a formamide conversion of from 80 to 98%, based on the total formamide introduced into the dehydration, is generally achieved by the process and the selectivity of hydrocyanic acid formation is generally from 85 to 96%.

U.S. Pat. No. 2,042,451 relates to a process for the catalytic dehydration of formamide to produce hydrocyanic acid. A heated surface (brass or iron) coated with a thin catalytically active oxide layer composed of zinc, manganese, aluminum, chromium or tin oxide serves as catalyst. According to the examples, formamide conversions of from 75 to 89% are achieved by the process according to U.S. Pat. No. 2,042,451.

DE-A-1 209 561 discloses a process for preparing hydrocyanic acid from formamide, in which ferric oxide deactivated by partial or complete binding of acids to form salts or by combination with one or more nonvolatile oxides of monovalent to hexavalent metals is used as catalyst. The catalysts are present in pelletized form or as catalyst grains formed in extruders. According to DE-A-1 209 561, a regenerated catalyst having the abovementioned catalytic components has a higher activity than the freshly used catalyst. The maximum yield of hydrocyanic acid is 94% according to the example given in DE-A-1 209 561.

DE-A-1 000 796 relates to a process for the dissociation of formamide vapor in order to prepare hydrogen cyanide, with a temperature gradient within the dissociation furnace being taken into account by the dissociation being carried out over highly fired, iron oxide-comprising silicates or spinels which are in the form of pieces or particles in a dissociation space whose wall has a lower catalytic activity than that of the catalyst in the dissociation space, with this wall consisting of, for example, stainless steel. Yields of hydrocyanic acid of 95% can be achieved by means of the process disclosed in DE-A-1 000 796.

DE-A-477 437 discloses a process for the catalytic preparation of hydrocyanic acid from formamide, in which substantially diluted formamide vapor is passed at high velocity at temperatures above 300° C. over metals as catalyst using metal tubes in the absence of water-eliminating catalysts. Suitable metals are cast iron, V2A steel, nickel and aluminum. According to DE-A-477 437, it is sufficient to produce the wall of the reaction vessel from the active metal or line the wall with the active metal. According to the examples, yields of hydrocyanic acid of from 90 to 98% are achieved by the process disclosed in DE-A-477 437.

WO 2011/089209 A2 discloses a process for vaporizing organic compounds and reacting them further. As an example of such a process, mention is made of the preparation of hydrocyanic acid by thermolysis of formamide. According to WO 2011/089209, the vaporization of the formamide is carried out in a single-chamber vaporizer. According to the description in

WO 2011/089209, hydrocyanic acid can be obtained in high selectivities of generally >90% and good conversions of generally >90% in the process described.

It is common to all the abovementioned processes that full conversion of formamide is not achieved. The partial conversion mode of operation makes recovery of unreacted formamide necessary. To avoid this separation of formamide from the crude gas with subsequent work-up, a mode of operation with full conversion of formamide would be desirable. A further advantage of a mode of operation with full conversion of formamide is the avoidance of high boiler formation during the work-up. However, the full conversion mode of operation founders on the high investment in significantly larger reactors or high pressure drops when using beds in the tubes of the shell-and-tube reactor usually used for the dehydration of formamide or simply on nonuniform distribution of the reaction gas stream over the individual tubes of the shell-and-tube reactor used, with breakthrough of unreacted formamide. In addition, high residence times necessary for achieving full conversion lead to decreases in selectivity.

In the light of the prior art, it is therefore an object of the present patent application to provide a process for the catalytic dehydration of formamide to produce hydrocyanic acid, which can be operated with very high conversions of formamide, preferably with full conversion of formamide, and in which the abovementioned disadvantages are avoided.

This object is achieved by a process for preparing hydrocyanic acid by catalytic dehydration of gaseous formamide, which comprises the steps
(i) catalytic dehydration of gaseous formamide in at least one main reactor to form an intermediate gaseous reaction product, where the conversion of formamide at the outlet from the main reactor is at most 95%, based on the formamide used, and
(ii) introduction of the intermediate gaseous reaction product into an after-reactor at an entry temperature of from 350 to 700° C., where the after-reactor comprises internals or beds composed of steel and is operated adiabatically. For the purposes of the present invention, internals are, for example, ordered packings.

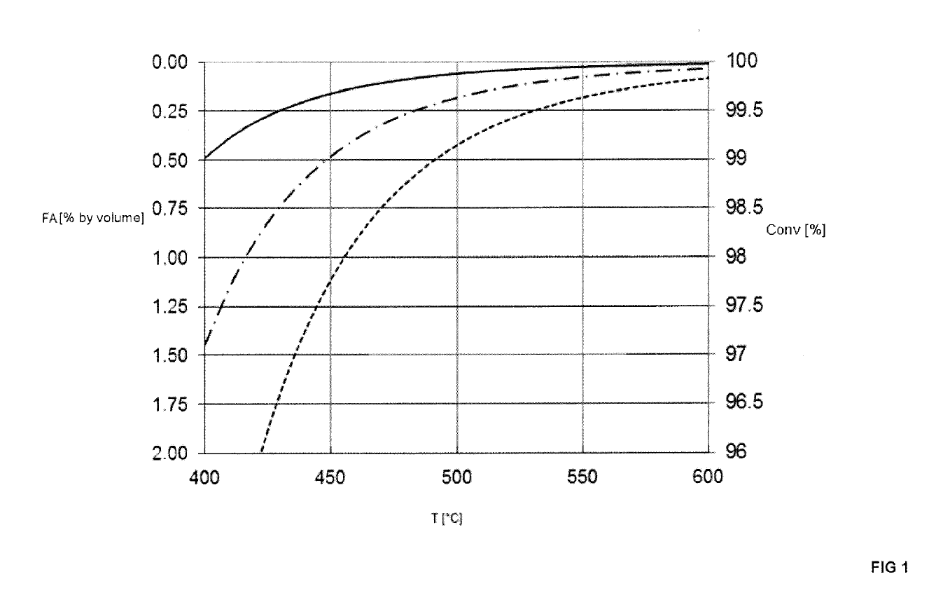

The process of the invention makes it possible to achieve high conversions of formamide, with full conversion of formamide being able to be achieved. The expression full conversion means a conversion of ≧98% of the equilibrium conversion (as a function of the temperature) of formamide (see, for example, FIG. 1). Formamide conversions which are ≧98%, preferably ≧99%, particularly preferably ≧99.5%, of the equilibrium conversion of formamide at the respective temperature are achieved by means of the process of the invention.

The graph depicted in FIG. 1 shows the residual formamide content in the offgas in % by volume (y axis) at a function of the temperature in ° C. (x axis) at full conversion relative to the equilibrium conversion. In this figure, the abbreviations have the following meanings:

| | |
|---|---|
| T[° C.] | Temperature in ° C. |
| FA [% by vol] | Residual formamide content in the offgas in % by |
| | volume |
| Conv [%] | Conversion of formamide in % |

The curves have the following meanings:

Solid line: Reaction pressure: 100 mbar
Dot-dash line: Reaction pressure: 300 mbar
Broken line: Reaction pressure: 700 mbar

The high formamide conversion can be achieved at good selectivities to hydrocyanic acid of >88%, preferably >90%, particularly preferably >93%.

The mode of operation according to the invention makes it possible to dispense with condensation with high boiler formation and back-distillation of unreacted formamide and the hot reaction gas can be quenched directly, usually in an ammonia absorber. Problems which usually occur as a result of polymer deposits in the formamide condensers can thus likewise be avoided.

For the purposes of the present patent application, “adiabatic” means that the system, i.e. the reaction mixture in the after-reactor, is converted without exchanging thermal energy with its surroundings (heat-tight).

### Step (i)

In step (i) of the process of the invention, the catalytic dehydration of gaseous formamide occurs in at least one main reactor to form an intermediate gaseous reaction product, where the conversion of formamide at the outlet from the main reactor is at least 95%, based on the formamide used.

The catalytic dehydration in step (i) can in principle be carried out by all processes known to those skilled in the art, with the conversion of the formamide at the outlet from the main reactor having to be at least 95%, based on the formamide used.

As reactor in step (i) of the process of the invention, it is possible to use all reactors known to those skilled in the art for the dehydration of formamide. Preference is given to using tube reactors comprising at least one reaction channel in step (i) of the process of the invention, with particular preference being given to the tube reactors being multitube reactors. Suitable tube reactors and multitube reactors are known to those skilled in the art.

The inner surface of the reactor used for the dehydration can serve as catalyst for the dehydration of formamide. An iron-comprising surface is therefore preferably used as inner surface of the reactor. The inner surface of the reactor is particularly preferably made of steel. The steel very particularly preferably comprises iron together with chromium and nickel. The proportion of iron in the steel which very particularly preferably forms the inner reactor surface is generally >50% by weight, preferably >60% by weight, particularly preferably >70% by weight. The balance is generally nickel and chromium, with small amounts of further metals such as molybdenum, manganese, silicon, aluminum, titanium, tungsten and cobalt optionally being able to be present in a proportion of generally from 0 to 5% by weight, preferably from 0.1 to 2% by weight. Preferred steel grades which are suitable for the inner reactor surface are generally steel grades corresponding to the standards 1.4541, 1.4571, 1.4573, 1.4580, 1.4401, 1.4404, 1.4435, 2.4816, 1.3401, 1.4876 and 1.4828. Preference is given to using steel grades corresponding to the standards 1.4541, 1.4571, 1.4828, 1.3401, 1.4876 and 1.4762, particularly preferably steel grades corresponding to the standards 1.4541, 1.4571, 1.4762 and 1.4828. The abovementioned tube reactor having an abovementioned inner surface makes catalytic dehydration of gaseous formamide to hydrocyanic acid in step (i) of the process of the invention possible without additional catalysts having to be used or the reactor additionally having internals.

However, it is likewise possible for the catalytic dehydration in step (i) of the process of the invention to be carried out in the presence of shaped bodies as catalysts in addition to the catalytically active inner reactor surface or instead of a catalytically active inner reactor surface.

The shaped bodies are preferably highly sintered shaped bodies made up of aluminum oxide and optionally silicon oxide, preferably of from 50 to 100% by weight of aluminum oxide and from 0 to 50% by weight of silicon oxide, particularly preferably of from 85 to 95% by weight of aluminum oxide and from 5 to 15% by weight of silicon oxide, or of chromium-nickel stainless steel as described in EP-A 0 209 039. Furthermore, suitable catalysts used in step (i) of the process of the invention can be packings composed of steel or iron oxide on porous support materials, e.g. aluminum oxide. Suitable packings are described, for example, in DE-A 101 38 553.

If shaped bodies are used, it is possible to use both disordered and ordered shaped elements, e.g. Raschig rings, Pall rings, pellets, spheres and similar shaped elements, as possible shaped bodies. It is important here that the packings make good heat transfer possible at a moderate pressure drop. The size and geometry of the shaped elements used generally depends on the internal diameter of the reactors, preferably tube reactors, to be filled with these shaped bodies.

Furthermore, the main reactor, preferably tube reactor, particularly preferably multitube reactor, used in step (i) of the process of the invention can have packings composed of steel or iron oxide as catalysts, with these generally being ordered packings. The ordered packings are preferably static mixers. The use of static mixers makes it possible to achieve a uniform pressure and excellent heat transfer in the reactor, preferably tube reactor. The static mixers can have any geometries known to those skilled in the art. Preferred static mixers are made of metal sheets, which can be perforated metal sheets and/or shaped metal sheets. It is of course likewise possible to use shaped perforated metal sheets. Suitable static mixers are described, for example, in DE-A 101 38 553.

In a preferred embodiment, the catalytic dehydration in step (i) of the process of the invention is thus carried out in the presence of shaped bodies selected from among highly sintered shaped bodies made up of aluminum oxide and optionally silicon oxide and chromium-nickel stainless steel shaped bodies or in the presence of packings composed of steel or iron oxide on porous support materials or in the presence of ordered packings composed of steel as catalysts and/or the inner reactor surface of the main reactor is made of steel and serves as catalyst.

In general, the catalytic dehydration in step (i) of the process of the invention is carried out at a temperature of from 350 to 700° C., preferably from 400 to 650° C., particularly preferably from 500 to 600° C. If higher temperatures are selected, decreased selectivities have to be expected.

The pressure in step (i) of the process of the invention is generally from 70 mbar to 5 bar, preferably from 100 mbar to 4 bar, particularly preferably from 300 mbar to 3 bar, very particularly preferably from 600 mbar to 1.5 bar, absolute pressure.

The catalytic dehydration in step (i) of the process of the invention is preferably carried out in the presence of oxygen, preferably atmospheric oxygen. The amounts of oxygen, preferably atmospheric oxygen, are generally from >0 to 10 mol %, based on the amount of formamide used, preferably from 0.1 to 9 mol %, particularly preferably from 0.5 to 3 mol %.

The optimal residence time of the formamide gas stream in step (i) of the process of the invention is, in the case of the preferred use of a tube reactor as main reactor, given by the formamide loading per unit area, which is generally from 0.1 to 100 kg/m², preferably from 2 to 50 kg/m², particularly preferably from 4 to 30 kg/m², divided by the internal surface area of the tube or of the multitube reactor. The dehydration is preferably carried out in the range of laminar flow.

Heating of the main reactor used in step (i) of the process of the invention is generally effected by means of hot burner offgases (circulation gas) or by means of a salt melt. Apart from natural gas for heating the salt melt or the circulation gas, the residual gas formed in the hydrocyanic acid synthesis can also be used. This generally comprises CO, H₂, N₂ and small amounts of hydrocyanic acid.

The dehydration in step (i) of the process of the invention is carried out to a formamide conversion of at least 95%, based on the formamide used. The selectivity to hydrocyanic acid is generally >85%, preferably >90%.

The intermediate, gaseous reaction product obtained by catalytic dehydration in step (i) of the process of the invention is, according to the invention, introduced at an entry temperature of from 350° C. to 700° C. into an after-reactor (step (ii) of the process of the invention).

### Step (ii)

Step (ii) of the process of the invention concerns the introduction of the intermediate gaseous reaction product into an after-reactor at an entry temperature of from 350° C. to 700° C., where the after-reactor comprises internals or beds composed of steel and is operated adiabatically. For the present purposes, internals are, for example, ordered packings.

Step (ii) of the process of the invention makes it possible to increase the formamide conversion in the process for the catalytic dehydration of gaseous formamide to the equilibrium conversion (full conversion). The equilibrium in the dehydration of formamide is temperature-dependent. At the abovementioned entry temperatures of from 450 to 700° C., formamide conversions of 98% of equilibrium conversion (full conversion of formamide) are achieved, preferably 99%, particularly preferably 99.5%.

To achieve these high formamide conversions, the after-reactor has internals, e.g. ordered packings or beds composed of steel, and is operated adiabatically.

The internals composed of steel in the after-reactor are preferably ordered packings, particularly preferably static mixers. The static mixers are very particularly preferably made of metal sheets, preferably perforated metal sheets and/or shaped metal sheets, with the perforated metal sheets also being able to be shaped perforated metal sheets.

A uniform pressure and excellent heat transfer in the after-reactor can be achieved by the use according to the invention of static mixers in the after-reactor.

Suitable static mixers are described, for example, in DE-A 101 38 553.

In a preferred embodiment of the process of the invention, the steel in the abovementioned beds or internals, e.g. ordered packings, preferably static mixers, preferably static mixers made of steel sheets, of the after-reactor is selected from among steel grades corresponding to the standards 1.4541, 1.4571, 1.4573, 1.4580, 1.4401, 1.4404, 1.4435, 1.4816, 1.3401, 1.4876 and 1.4828, preferably selected from among steel grades corresponding to the standards 1.4541, 1.4571, 1.4828, 1.3401, 1.4876 and 1.4762, particularly preferably from among steel grades corresponding to the standards 1.4541, 1.4571, 1.4762 and 1.4828.

The after-reactor in step (ii) of the process of the invention is usually operated at the same pressure as the main reactor or at the pressure in the main reactor less the pressure drop. This means that, in a very particularly preferred embodiment, the exit pressure of the gaseous, intermediate reaction product obtained in step (i) from the main reactor and the entry pressure of the gaseous, intermediate reaction product obtained in step (i) into the after-reactor in step (ii) of the process of the invention are identical in each case. The pressure in the after-reactor in step (ii) is generally from 70 mbar to 5 bar, preferably from 100 mbar to 4 bar, particularly preferably from 300 mbar to 3 bar, very particularly preferably from 600 mbar to 1.5 bar, absolute pressure.

In a particularly preferred embodiment of the process of the invention, the exit temperature of the gaseous, intermediate reaction product obtained in step (i) from the main reactor and the entry temperature of the gaseous, intermediate reaction product obtained in step (i) into the after-reactor in step (ii) of the process of the invention are identical in each case. The temperature in the after-reactor in step (ii) is generally from 350 to 700° C., preferably from 400 to 650° C., particularly preferably from 500 to 600° C.

Before introduction of the intermediate, gaseous reaction product into the after-reactor in step (ii), oxygen, preferably atmospheric oxygen, can optionally be fed into the intermediate, gaseous reaction product from step (i) in order to avoid deposits on the ordered packings of the after-reactor. In addition, oxygen can serve to increase the catalytic activity of the catalytic material used in the after-reactor.

The hydrocyanic acid selectivity which can be achieved by means of the after-reactor in step (ii) of the process of the invention is generally from 70 to 100%, preferably from 90 to 100%, particularly preferably from 93 to 100%.

### Vaporization of Formamide

The gaseous formamide used in the process of the invention in step (i) is obtained by vaporization of liquid formamide. Suitable processes for vaporizing liquid formamide are known to those skilled in the art and are described in the prior art mentioned in the introductory part of the description.

In general, vaporization of the formamide is carried out at a temperature of from 110 to 270° C. The vaporization of the liquid formamide is preferably carried out in a vaporizer at temperatures of from 140 to 250° C., particularly preferably from 200 to 230° C.

The vaporization of the formamide is generally carried out at a pressure of from 20 mbar to 3 bar. The vaporization of the liquid formamide is preferably carried out at an absolute pressure of from 80 mbar to 2 bar, particularly preferably from 600 mbar to 1.3 bar.

The vaporization of the liquid formamide is particularly preferably carried out at short residence times. Very particularly preferred residence times are <20 s, preferably <10 s, in each case based on the liquid formamide.

Owing to the very short residence times in the vaporizer, the formamide can be virtually completely vaporized without by-product formation.

The abovementioned short residence times of the formamide in the vaporizer are preferably achieved in millistructured or microstructured apparatuses. Suitable millistructured or microstructured apparatuses which can be used as vaporizer are described, for example, in DE-A 101 32 370, WO 2005/016512 and WO 2006/108796. A further method of vaporizing liquid formamide and also a suitable microvaporizer are described in WO 2009/062897. Furthermore, it is possible to carry out the vaporization of liquid formamide in a single-chamber vaporizer as described in WO 2011/089209.

In a preferred embodiment of the process of the invention, the gaseous formamide used in step (i) is thus obtained by vaporization of liquid formamide at temperatures of from 100 to 300° C. using a millistructured or microstructured apparatus as vaporizer. Suitable millistructured or microstructured apparatuses are described in the abovementioned documents.

However, it is likewise possible to carry out the vaporization of the formamide in classical vaporizers.

### Reaction Gas Quench and NH₃ Absorber

The process of the invention has the advantage that a high formamide conversion, preferably full conversion, relative to the equilibrium conversion of formamide is achieved. For this reason, condensation with high boiler formation and backdistillation of unreacted formamide can generally be dispensed with and the hot reaction gas leaving the after-reactor can be quenched directly in the NH₃ absorber.

The quenching of the hot tube gas stream which leaves the after-reactor and comprises hydrocyanic acid gas is usually carried out by means of dilute acid, preferably by means of dilute H₂SO₄ solution. This is usually circulated by pumping via a quenching column. Suitable quenching columns are known to those skilled in the art. At the same time, the NH₃ formed is bound as ammonium sulfate. The heat (gas cooling, neutralization and dilution) is generally removed by means of a heat exchanger (usually cooling water) in a pumped circuit. At quenching temperatures of generally from 50 to 560° C., water is condensed out at the same time and is generally discharged as dilute ammonium sulfate solution via the bottom and disposed of. If a partial amount vaporizes at the bottom or in a downstream separation apparatus (embodiments of downstream separation apparatuses are known to those skilled in the art), hydrocyanic acid dissolved in the bottoms can be removed. The bottom product can thus be used, for example, as fertilizer. A hydrocyanic acid gas stream comprising from about 70 to 99% of hydrocyanic acid leaves the top of the quenching column. This can further comprise CO, CO₂, water and H₂.

### Optional Compressor

It is possible for the quenching column to be followed by a compressor which compresses the gas leaving the top of the quenching column to a pressure corresponding to a desired process for further processing of the hydrocyanic acid gas stream. This process for further processing can be, for example, a work-up to give pure hydrocyanic acid or any further reactions of the gas stream comprising hydrocyanic acid.

The use according to the invention of the after-reactor in the process of the invention makes it possible to achieve a high formamide conversion up to full conversion of formamide, based on the equilibrium conversion of formamide, with a simultaneously high hydrocyanic acid selectivity. The present invention therefore further provides for the use of an after-reactor in a process for preparing hydrocyanic acid by catalytic dehydration of gaseous formamide, where the after-reactor comprises internals, e.g. ordered packings or beds composed of steel, and is operated adiabatically.

Suitable after-reactors and reaction conditions in the respective after-reactors have been mentioned above. Furthermore, a suitable process for the catalytic dehydration of formamide has been mentioned above.

The following examples illustrate the invention.

### EXAMPLES

The measurements shown in table 1 are carried out in a shell-and-tube reactor which has 1.4 m long reaction tubes composed of 1.4541 steel and is heated by circulation gas.

The figures given in each case relate to one tube. The reactor is followed by a 1 m long after-reactor. The after-reactor is equipped with sheet metal packing having a surface-to-volume ratio of 250 m²/m³ (MONTZ-Pak type B1-250.60 Material 1.4541, material thickness: 1 mm). The after-reactor is operated at a superficial velocity of 9.4 m/s. The detailed conditions are shown in the following table.

TABLE 1

| Feeds | | Temperatures | | Pressures | | Downstream | | Downstream | |
|---|---|---|---|---|---|---|---|---|---|
| to main | | Main | After- | Main | After- | of main | | of after- | |
| reactor | | reactor | reactor | reactor | reactor | reactor | | reactor | |
| Formamide | Air | outlet | outlet | outlet | outlet | Conversion | Selectivity | Conversion | Selectivity |
| [l/h] | [kg/h] | [° C.] | [° C.] | [mbar] | [mbar] | [%] | [%] | [%] | [%] |
| 5.63 | 0.40 | 477 | 454 | 129.00 | 123.00 | 92.55 | 92.18 | 97.35 | 91.47 |
| 5.47 | 0.38 | 487 | 468 | 126.00 | 121.00 | 94.76 | 92.38 | 98.13 | 92.06 |

1. A process for preparing hydrocyanic acid by catalytic dehydration of gaseous formamide, comprising
(i) catalytic dehydration of gaseous formamide in at least one main reactor to form an intermediate gaseous reaction product, where the conversion of formamide at an outlet from the at least one main reactor is at least 95%, based on the formamide used, and
(ii) introduction of the intermediate gaseous reaction product into an after-reactor at an entry temperature of from 350 to 700° C., where the after-reactor comprises internals or beds composed of steel and is operated adiabatically.

2. The process according to claim 1, wherein the catalytic dehydration in (i) is carried out in a tube reactor comprising at least one reaction channel.

3. The process according to claim 1, wherein the catalytic dehydration in (i) is carried out in the presence of shaped bodies selected from among highly sintered shaped bodies comprising aluminum oxide and optionally silicon oxide and chromium-nickel stainless steel shaped bodies or in the presence of packings comprising steel or iron oxide on porous support materials or in the presence of ordered packings comprising steel as catalysts and/or the inner reactor surface of the main reactor is made of steel and serves as catalyst.

4. The process according to claim 1, wherein the catalytic dehydration in (i) is carried out at a temperature of from 350 to 700° C.

5. The process according to claim 1, wherein the catalytic dehydration in (i) is carried out at a pressure of from 70 mbar to 5 bar, absolute pressure.

6. The process according to claim 1, wherein the catalytic dehydration in (i) is carried out in the presence of oxygen.

7. The process according to claim 1, wherein the catalytic dehydration in (i) is carried out at a formamide loading per unit area of from 0.1 to 100 kg/m2, based on an inner surface area of the tube or of the multitube reactor.

8. The process according to claim 1, wherein the internals in the after-reactor in (ii) are ordered packings.

9. The process according to claim 8, wherein the ordered packings are a static mixer, and the static mixer comprises of metal sheets.

10. The process according to claim 1, wherein the steel in the internals or beds of the after-reactor in (ii) is selected from among steel grades corresponding to the standards 1.4541, 1.4571, 1.4573, 1.4580, 1.4401, 1.4404, 1.4435, 1.4816, 1.3401, 1.4876 and 1.4824.

11. The process according to claim 1, wherein the after-reactor in (ii) is operated at a pressure of from 70 mbar to 5 bar, absolute pressure.

12. The process according to claim 1, wherein the gaseous formamide used in (i) is obtained by vaporization of liquid formamide at a temperature of from 110 to 270° C.

13. The process according to claim 12, wherein the vaporization of the formamide is carried out at a pressure of from 20 mbar to 3 bar.

14. The process according to claim 12, wherein a millistructured or microstructured apparatus is used as vaporizer.

15. (canceled)
